(19) United States
(12) Patent Application Publication
(10) Pub. No.: US 2002/0052925 A1
(43) Pub. Date: May 2, 2002

(54) Method and apparatus for information delivery on the internet

(76) Inventors: Yoohwan Kim, Morganville, NJ (US); Dean Chung, Glencoe, IL (US)

Correspondence Address: SCHIFF HARDIN & WAITE, 6600 SEARS TOWER, 233 S WACKER DR, CHICAGO, IL, 60606-6473, US

(21) Appl. No.: 09/940,923

(22) Filed: Aug. 28, 2001

Related U.S. Application Data
(60) Provisional application No. 60/228,690, filed on Aug. 29, 2000.

(51) Int. Cl. G06F 15/16

(52) U.S. Cl. 709/217

(57) ABSTRACT

A system and method are provided for delivering targeted multimedia or video advertisements over the Internet while protecting user privacy. A software application is executed while the browser application runs in a user's computer. The application periodically accesses the server over the Internet to download targeted advertisements during user idle time and stores them locally. When the user activity meets a predefined criteria, e.g., user's mouse clicking action causing a web page transition, the application picks up matching content based on priority and keyword, then presents the primary section of the content partially inside user's browser, and then catalogs it to allow the user to retrieve later the full primary content and the secondary content. The application logs statistical information without any user identification information relating to the presentation of advertisements and establishes a communication with the server from time to time to make the logged information available to the server system. The server stores and updates a database of the information so that the advertisements can be delivered to appropriately selected users.

### CROSS-REFERENCE TO RELATED APPLICATION

The present application claims the benefit of U.S. Provisional Application No. 60/228,690, filed Aug. 29, 2000.

### BACKGROUND OF THE INVENTION

1. Field of the Invention

This invention relates to a method and apparatus for delivering information electronically, and particularly, to techniques for delivering information including advertising. In particular, it relates to a method and system for presenting the information, reporting the recipients' activity, targeting the recipients, and archiving the delivered information in an electronic information delivery network.

2. Description of the Related Art

Delivery of messages not requested by the recipient, such as advertising, and getting the advertisement noticed by the recipient has been difficult through any medium including TV, magazines, or newspapers, and especially on the Internet.

A vast potential of the advertising on Internet has been underutilized due to the lack of technologies. While the banner ads that accompany many Web sites have become a familiar part of the Web landscape, many advertisers are questioning their effectiveness in enticing customers. With online ad effectiveness declining and advertisers experiencing low click-through rates on traditional banner ads, advertisers are seeking more powerful forms of online advertising. The Internet advertising industry has been looking for a method to deliver TV-like multimedia presentations to the users' screen(s); such technology was not readily available or very crude to date.

Banners: This is the most popular method in today's web advertising. A fixed size of banner is embedded in a web page. There are several different kinds of banners, static image banner, animated image banners, interactive banners, HTML banners and rich media banners. Rich media banners are big in terms of data size and are more expensive to create but very effective compared to other banners.

Fixed Banner Window: Ads are served in a window that stays open. This method is used by most free ISPs and ad delivering companies that pay the users.

Interstitials are advertisements that pop onto the screen and interrupt users. Its original meaning is “between pages”, that is it appears while the user waits for new page after clicking a link. But it is used as a synonym for pop-up windows, and sometimes is called e-mercials or inter-mercials. This ad is similar to TV ads and advertisers like Interstitials because these will be noticed. The problem with Interstitials is often consumers are upset and bothered, so advertisers are now using smaller windows less than ½ of the screen.

E-mail including sponsoring discussion list and e-mail newsletters, direct e-mail arid ad-supported email such as hot-mail which attaches an advertising message when the user uses free email service.

Push Technology Advertisements are sent directly to a user rather than waiting for the users to visit.

Particularly on the Internet, the creativity of advertising production and targeting capability has approached its limit, and as a result, the advertisement recall rates and click-through rates are constantly declining, requiring a breakthrough method.

A few methods attempt to deliver rich media, but they have had only limited success and the majority of Internet advertising is still delivered via banners. From the user's point of view, the disadvantages of banners include:

Slowing down web access speed: it interferes with downloading of the users' content, moreover it further slows down the effective speed of the Internet access by forcing re-downloading of the advertising banners for already cached pages in users' computers.

Reduced screen “real estate:” It sacrifices valuable users' space from the screen, which is worse with the fixed banner bars outside of the browsers that are provided with free ISP (Internet Service Provider) services.

No backtracking: Often times, a user cannot make an immediate decision on purchasing from the AD (advertisement) but still they may feel it is valuable information in the future. Currently, there is no way to backtrack to the banner or efficiently search the ADs which were previously viewed.

No offline support: A large percentage of purchasing is made off-line after acquiring product information on-line. However that information, e.g., a toll free telephone number, is rarely saved and the users are forced to re-connect to the network and attempt to search for the same information. From the advertisers' point of view, the disadvantages include:

Transaction-oriented but not for branding: Most banners provide a link to an e-commerce (electronic commerce) site to promote purchasing, but they rarely have inherent value for emphasizing a product image. As a result, many advertisers who want to simply get their name out are locked out from the Internet advertising space. This factor has significantly limited the growth of the Internet advertising revenue, as the market share of Internet advertising is limited to a few percent of the total advertising market despite the Internet's wide penetration.

No active delivery: Banners are passively delivered only to the visiting users. Only those using fixed banner bars by free ISPs have limited active delivery function.

No guaranteed delivery: Users frequently stop the downloading of banner or scroll up or down to avoid exposure to banner. Even when the user looks at the banner, their attention is at the content of the site, not at the banner.

Low recall rate: Users hardly notice and remember the banners nowadays. Click through (which means clicking on the banner ad which directs the user to another site) rates are considered to be less than 0.3%.

Low click through and high cost: Due to the extremely low click-through rate, the original purpose of banner, attracting users to e-commerce sites (electronic commerce), is hardly served, consequently, the effective cost of banner advertising is getting higher every day.

Imprecise targeting: Despite of all the tricks using cookies, it is still difficult to profile users' characteristics accurately to provide individually targeted ADs. So current targeting relies on generic targeting by placing the banners on web pages pertaining to specific interests.

Difficult segmentation: Web pages are open to the world without control as to who views the AD. So visiting by local users is only statistically anticipated.

Slow distribution: Many advertisers want to distribute an advertising message to a broad audience in a short amount of time. However, most web sites attract a small number of visitors per day and only a few web sites have the name recognition to drawing large numbers of visitors.

A new advertising method is in great need which is preferably capable of delivering TV “commercial style” multimedia advertisements in an unforgettable fashion with little or no annoyance to the user. Due to networking speed, file formats and size limitations, delivering and presenting such content cannot be performed effectively using existing technology.

Even with other new technologies, these problems cannot be solved completely.

For example, traditional advertisers need to integrate their campaigns across all media. The emergence of the Internet as a significant advertising channel has increased the pressure on traditional advertising agencies to provide competitive services for Internet advertising. Until recently, these companies have been significantly disadvantaged by their lack of understanding of the Internet as a marketing medium and their lack of technical sophistication.

Despite these challenges, traditional advertising agencies have strength and market share in traditional advertising media, such as TV commercial, newspaper, local advertising and magazines. As a result, these companies need technologies that enable them to migrate their businesses to the Internet model. Specifically, they need a technical interface between the traditional advertisement and the Internet advertisement. Using an AD agency, traditional advertising agencies can offer multi-channel advertising campaigns to their business clients.

In addition to the problems listed above, problems with banner ads that constrain growth for 3rd party brokers include:

Size—Too small for effective advertising

Loose connections to e-commerce servers—The connection is alive only when the banner icon is downloaded in the web page

Third party AD brokers requires a more feature rich tool to maximize revenue. AD Agency/Server provides this with the following features:

Bigger & more effective advertising

More advanced targeting & market research information

Tight connection to E-commerce servers

Advertisers want proof that the ads they pay for wind up on consumer monitors, not downloaded halfway, or never seen at all. The current Internet advertisement cannot guarantee that it is actually displayed on the web Site. They have been looking for a strategic alignment in the Internet advertisement as a part of whole advertising campaign.

There are over 8000 ISPs in United States. Except a few dozen of big ISPs, many of them are struggling for survival with low margin. They are looking for a solution to increase their revenue from other sites so that they can offer a cheaper service fee to their subscribers. Increasing advertisement revenue provides a way to raise the revenue us ISPs. For example, they are employing these techniques including providing AD during dial-up time, providing pop-up advertisement, toolbar for advertiser, recycling error page with ad message etc. To make the situation worse, dial-up providers are losing customers to broadband providers and Free ISPs.

Pioneered by NetZero in late 1998, free ISP or sponsored ISP, has now become a popular trend. Two type of free ISPs are in existence today, one is ISP based on purely advertising revenue such as NetZero, Freei or Juno, the other is aiming to draw more traffic to their web site and providing a branding image for own company, such as Yahoo! Kmart. However, their current adverting revenue is not being maximized due to the limitation of present Internet advertising method, i.e. fixed banner window.

Both paid ISP and free ISP is in need of advanced advertising tool for extra revenue generation, such the present invention, to deliver high-profit advertisements. In addition, as small ISPs focus on local and the regional market place, because of the lack of economy of scale, it is difficult to generate advertising revenue. Therefore, consolidation service for collecting and distributing advertisements is required.

In addition, the news tools provide a new revenue stream for ISP industry that is critical for their survival. One objective is providing an innovative framework for Internet advertising that can greatly benefit traditional advertisers and ad agencies, and consolidate the Internet advertising collection and distribution with lower service fee.

### SUMMARY OF THE INVENTION

The present invention provides a method to resolve the aforementioned shortcomings of current Internet advertising methods by using a full-browser based on-click advertisement presentation and information retrieval through an e-catalog. The full-browser means that the information is presented using the entire display window. The on-click presentation means that the presentation is triggered by a user's action.

An example of one of the target areas for the present invention is Internet advertising. For that reason, the term advertising will be used for illustration purposes whenever appropriate throughout this document, but the principle idea and method can be applied to many other areas where information must be delivered to targeted audience over Internet. According to this invention, an advertisement is uploaded to an advertising server which is a web server, delivered to a precisely targeted group through keyword-based profiling without interfering with the user's bandwidth, and presented at relevant moments through various match algorithms. The information or advertisement, once presented, is transferred to an e-catalog (electronic catalog) along with more detailed information, which provides automatic categorization, automatic expiration, or update. The client software controls the user's web browser for on-click instant fall-browser presentation, while the servers deliver the files and do all the background processing.

This invention continuously monitors the user's activity while the user is on line and downloads advertising materials when the user's activity is low, storing the materials in the user's local storage. Thus a large amount of information, such as multi-media, can be downloaded without slowing down the user's activity even over a narrow band channel. For the presentation of materials, the present invention utilizes the transition time from one page to another where users must typically endure blank screens and are waiting for the new web page downloading. Since the materials are already stored in the user's local storage before presentation, presentation of large materials, such as TV-like advertisements are executed instantly without further download. The presentation materials include advertisements, multi-media data, cartoons, study material, and news broadcasts.

Showing a full browser advertisement during the transition time has several advantages. Users feel as if the web access speed becomes faster, since it is more entertaining to watch the animation instead of a blank page. During the transition time, users are naturally expecting a transition and the attention level is high, and no other information is cluttered during this time, so the effectiveness of advertising is much higher and less annoying.

Using this invention, the advertisers can send information without annoying users, yet the message is very likely to get noticed, and it gets automatically deleted after some period (e.g., one month) without being visible to the user. It effectively presents locally stored materials according to the user preference based on the user's clicking or typing activity when he or she browses information. Besides the on-click presentation, the present invention provides an e-catalog system, which archives materials systematically for user retrieval. Users can conveniently access this information when they need it either on-line or off-line. An advertisement may be composed of a primary section that is presented during the web page transition and secondary information that includes more detailed product information. When the user requests retrieval of the information from the e-catalog, all primary content and secondary content is displayed.

All the on-line and off-line browsing information and logs of on-click presentation can be collected and reported to the server for marketing analysis. Based on the analysis of such data reported by the user side software of the present invention, the server can release new content to a targeted audience, thus the content, for example advertisements, can be customized for each user's preference. Customers who provide the information content to be presented by the client can check the effectiveness of the advertisements based on the data analysis, which includes the user's browsing activity, the presentation status of the advertisements, and the usage of each entry in the e-catalog. Customers can also control the priority and targeting of the already delivered advertisement materials and can decide on new advertisements and control information.

One of the best target areas for this invention is Internet advertising. For that reason, the term advertising will be used for illustration purposes whenever appropriate throughout this document, but the principle idea and method can be applied to many other areas where information must be delivered to a targeted audience over the Internet.

A method of delivering information including but not limited to multimedia advertising content using on-click full browser instant presentation wherein working program codes serve a message delivery network and network delivery process, monitor user's network access speed and download the advertising contents, present the advertising content in full-browser to maximize the user's attention, match the domain name with advertising content, reports and profiled all internet activities, analyzes targeted information placement and archive(s) the information content delivered with user retention available.

The information delivery and archival method on the Internet using full-browser based on-click instant presentation and electronic catalog, wherein software receives individually tailored information contents from server, presents it in WWW browser instantly upon click for short duration before a target page is loaded. The information is temporarily archived for later retrieval, which could hold more detailed information in addition to the brief instant presentation. All activities during on-line and off-line browsing are logged and reported to the server so the server can deliver best-suited messages for the user. This method can be used for Internet advertising, such as delivering TV-like multimedia commercials, but can be used for many other purposes such as delivering new flash, movie clip, weather report, stock quote, music, or study material, etc.

The invention relates to techniques for delivering information electronically, and more particularly, to techniques for delivering information (including advertising). The present invention relates to a system and method or methods for presenting information, reporting the recipients' activity, targeting the recipients, and archiving the delivered information in an electronic information delivery network.

The invention allows the delivery of TV-like animation advertisement with minimal intrusion to the users but also has many other distinguished but critical features that have been long sought after by the advertisers. Those features will allow the existing players to survive or even to thrive in the competitive Internet marketplace environment.

An embodiment of the present invention provides a method to resolve most of the above shortcomings of the current Internet advertising methods using full-browser based on-click ad presentation and information retrieval through e-catalog. In the present invention, an advertisement is placed through a specialized web site, delivered to precisely targeted group through keyword-based profiling without interference of the user's bandwidth and presented at most relevant moment through various matched algorithms. The information or advertisement once presented is transferred to E-catalog along with more detailed information, which provides automatic categorization, automatic expiration or update. The client software controls user's web browser for on-click instant full-browser presentation, while the servers deliver the files and do all the background processing.

Using the present invention, the advertisers can send information without annoying users, yet the message is guaranteed to be noticed, and is automatically deleted after a period without inconvenience to the user. Users can conveniently browse the information when they need it either on-line or off-line. All the on-line and off-line browsing information is collected and reported to the server for marketing analysis.

### BRIEF DESCRIPTION OF THE DRAWINGS

FIG. 1 illustrates screen displays of web browsing according to the prior art;

FIG. 2 illustrates screen displays of web browsing utilizing the present invention;

FIG. 3 is a functional block diagram showing the basic modules of the present invention;

FIG. 4 is a functional block diagram that illustrates the information delivery network architecture;

FIGS. 5a, 5b, 5c and 5d illustrate the process of background information transfer;

FIG. 6 is a flow diagram of a routine that applies matching algorithms to advertisements;

FIG. 7 is a flow diagram of a routine that applies priority rules when there are plural matches and performs frequency control of each advertisement;

FIG. 8 illustrates screen displays showing the integration of a full-screen advertisement and banner advertisement;

FIG. 9 is a flow diagram of a routine that performs the process of integrated advertisement presentation;

FIG. 10 is a block diagram which illustrates the profiling and targeting process;

FIG. 11 is a block diagram which illustrates the AD archival process in the e-catalog system;

FIGS. 12-16 are screen displays which illustrate e-catalog display examples.

### DETAILED DESCRIPTION OF THE PREFERRED EMBODIMENTS

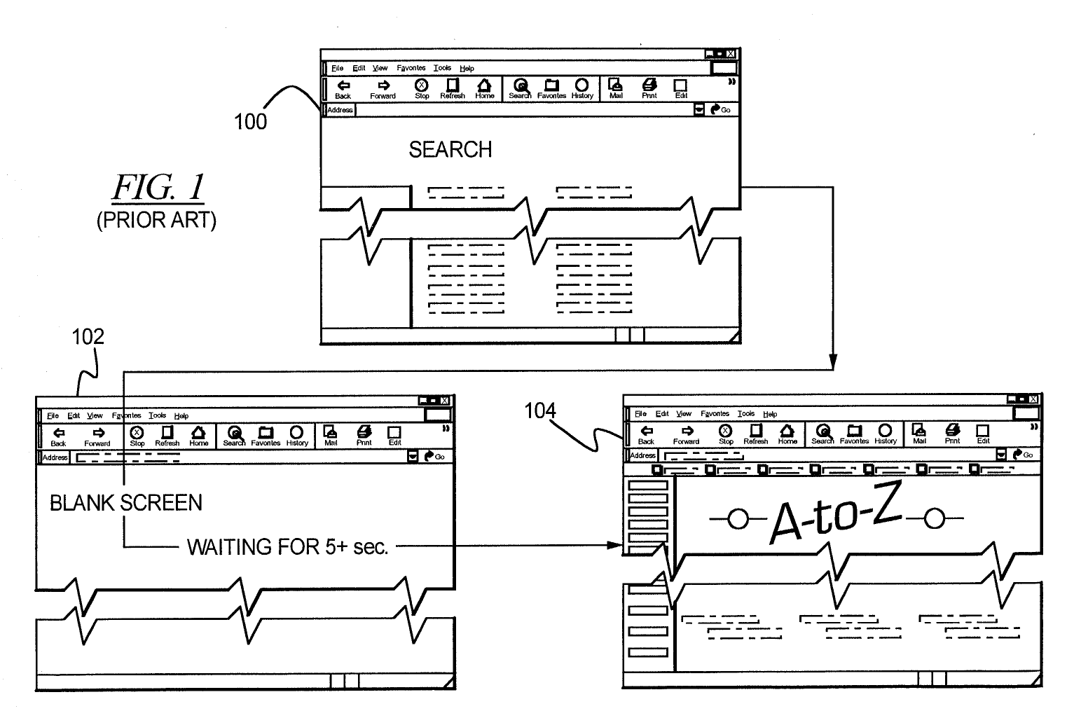

Turning first to FIG. 1, a display screen image of an Internet browser program of the prior art is shown at 100. The display screen 100 shows the display of a so-called search engine by which users search out information and sites, for example on the World Wide Web portion of the Internet. When a user selects a link to a search result or otherwise chooses another site to view, the content window of the browser display temporarily goes blank, as shown at 102. After a wait, that depends upon the speed of the user's Internet connection, the traffic load on the Internet, and the traffic load on the server being accessed, the new site is displayed, as shown at 104.

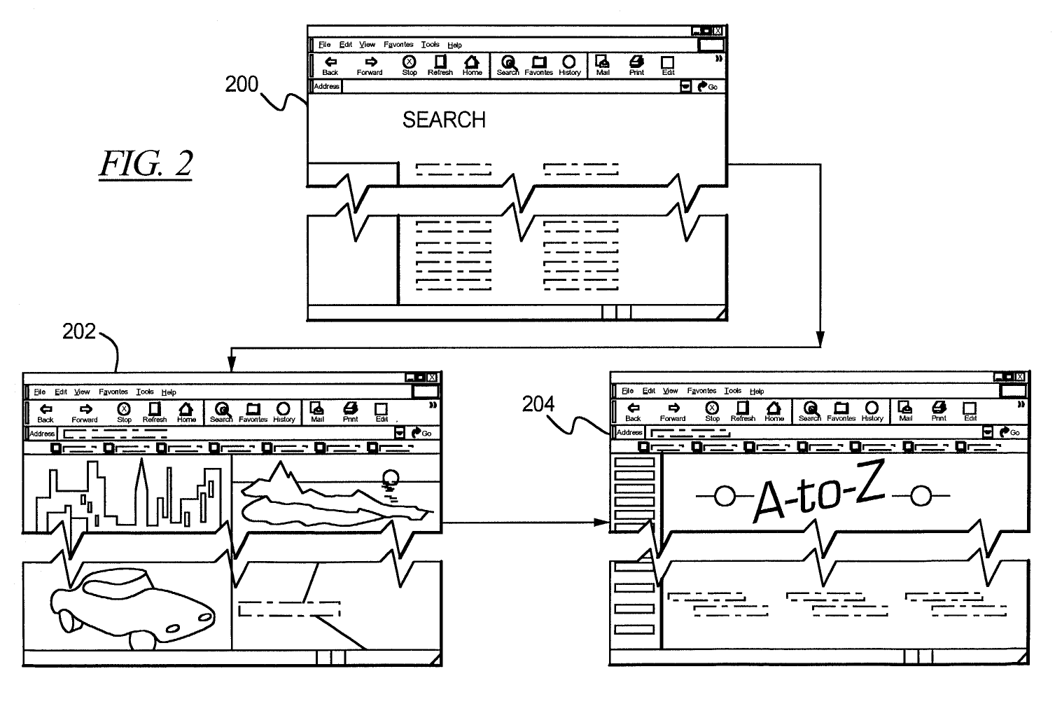

FIG. 2 shows the display sequence resulting from the use of the present invention. In particular, the Internet browser program shows the information from the search engine site at 200. The user selects a new site and while the browser program is retrieving the data from the server over the Internet, a transition screen is displayed, as shown at 202. This transition screen includes a full browser advertisement during the transition time between displays of the previous information and the new site information. The data for generating the transition advertisement is stored locally on the user's computer so the access is fast, nearly instantaneous, and large files can be accessed including video, animations, news, and multimedia materials. The user is waiting for the newly selected content from the new site as shown at 204, and so the user's attention is high and the advertising is therefore more effective than if presented in conjunction with the content that the user is seeking.

### Information Storage and Presentation

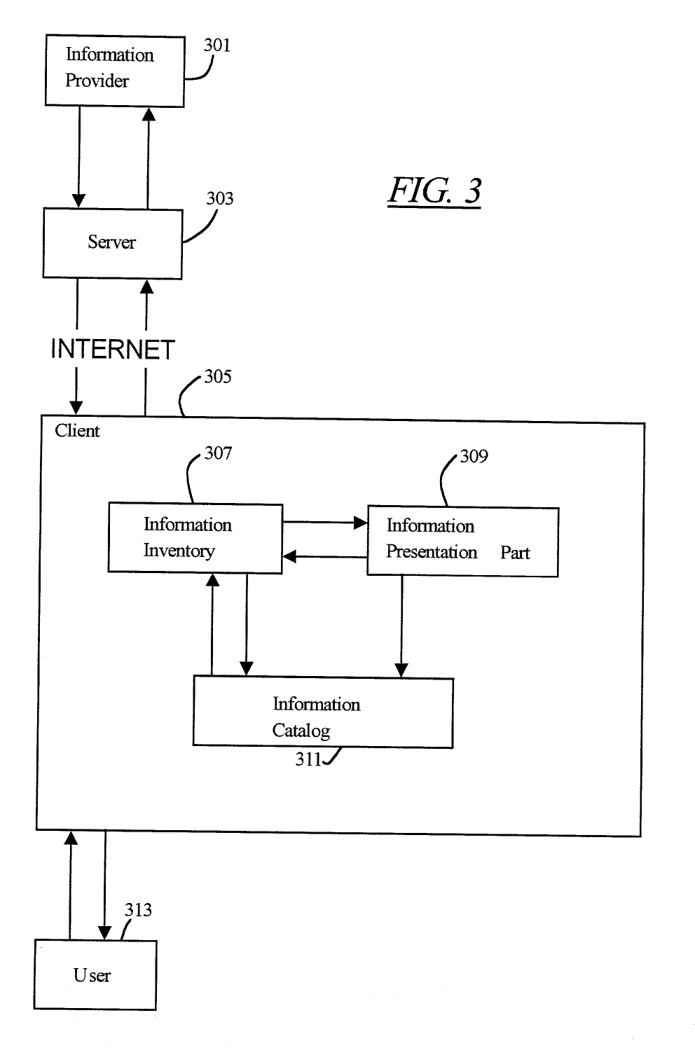

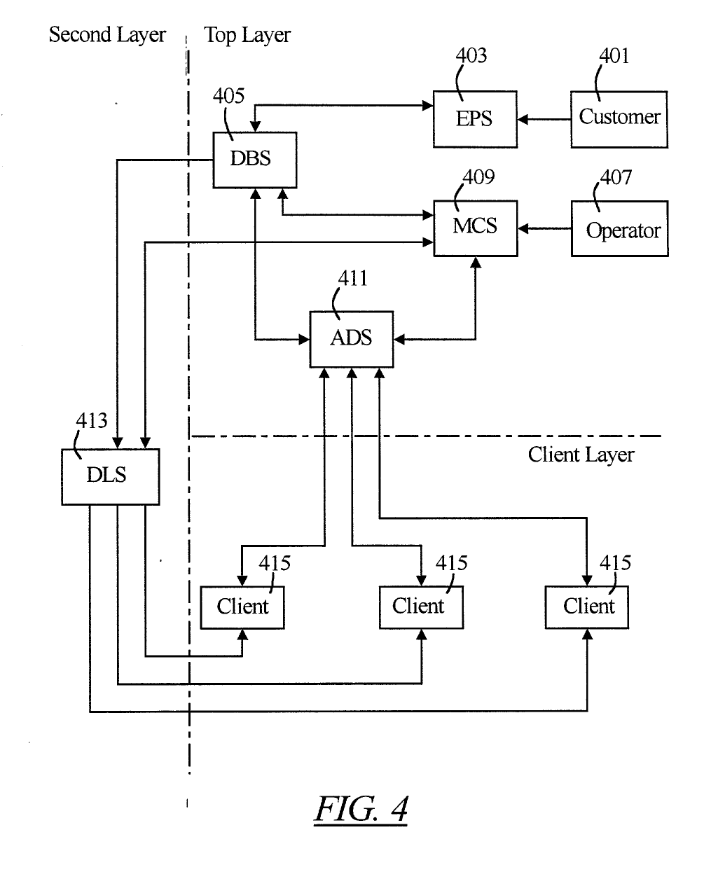

The present invention provides client-controlled information storage and a presentation system in a network comprising servers and clients. FIG. 3 illustrates the basic construction of the present invention. The system includes three basic modules: an information provider module 301, a server 303, and a client 305. The modules are identified by their functions. The actual number of servers varies according to their functions and capacities as explained later with regard to FIG. 4. The actual number of information providers and clients are naturally plural since the system is intended for networks and are only limited by the physical capacity of the networks. The information provider 301 provides information to the server 303 for distribution among the clients 305. The information is centrally stored in the server 303 and is delivered to the client 305 over the network. The client 305 has three modules, an information inventory 307, an information presentation part 309, and an information catalog 311. The information inventory 307 stores the information delivered to the client 305. The information presentation part 309 presents the information to a user 313 of the client 305 in a manner not bothering the user's normal activity. The information catalog 311 organizes the information so that the user 313 can refer to and use the information. The users of the client 305 do not request the information positively. The information provider 301 provides the information with the intention of interesting the user 313. The user can enjoy the automatic presentation of the information by the information presentation part 309, and can actively retrieve and use the information by the information catalog 311. The client 305 reports to the server 303 with data about the contents of the information inventory 307, the presentation status of the information, and the usage of the information catalog 311. The server 303 processes the data for each client 305, stores the data and reports to the information provider 301. The information provider 301 analyzes the data stored in the server 303, revises its strategy for providing information, and provides new information to the server 303. This information providing and reporting of the information use status are continued between the information provider 301 and the user 313. The client 305 performs storing, presenting, and organization of the information locally in the user's machine in which the client is installed. The information is delivered over the network using the bandwidth not actively used by the user. A large amount of information can be delivered without bothering the user since it is delivered whenever the client 305 is on line and the user 313 is not actively using the bandwidth of the network. Since the information is stored and presented locally by the client 305, the information is rich in content and is presented nearly instantly.

An example of the process of installing, running, and maintaining the client software is explained. In this example, the server is a web server and the network is the Internet. When a user 313 visits a website owned by an information provider 301, the website suggests that the user download and install the client software. After installation in the user's computer, the client 305 continuously downloads advertising materials until a pre-determined amount of materials is stored in the client. After that, the client downloads materials when new materials are released. The client 305 always communicates with the server 303 by uploading log data of usage of the materials and downloading client program update information and advertisement presentation control update information, etc. The server can update client software and control information remotely. The client is automatically invoked when a browser is started and the invocation process is transparent to the user. On the other hand, the client includes dial-up networking functions and the user can connect to the Internet by starting the client program without invoking other internet connection programs.

### Information Delivery Network and Process

The network architecture of the present invention is composed of three-tier components, two server layers and one client layer as illustrated in FIG. 4. The top layer servers have all the core database information, advertisement posting/monitoring, target profiling and web interface functions. The second layer servers can be placed anywhere in the TCP/IP (Transmission Control Protocol/Internet Protocol) networks to receive the contents and deliver them to the end-users. Multimedia files are larger in size and take more bandwidth, so serving all the clients from one place may overload the network. By distributing the servers for final delivery at the edge of the network, the advertising files are only delivered once to the delivery servers, thus avoiding network congestion and reducing the network cost. A two-layer server architecture helps to reduce the network traffic, thus accelerating the speed and reducing the network cost. Under a light load, those two servers may be merged. On the top layer server, the advertiser browses the subscriber information, and uploads the advertisement. The client interface, possibly by a web interface, shows the number of total subscribers, number of targeted groups, the advertising price, etc. Once a message is uploaded, it is delivered to tier two servers and they notify the clients' software to download the messages. The client then retrieves the messages autonomously.

FIG. 4 is a schematic diagram of the information delivery network architecture of the present invention. The top layer includes a customer 401, an electronic procurement server (EPS) 403, a database server (DBS) 405, an operator 407, a monitor-and-control server (MCS) 409, and an advertisement distribution server (ADS) 411. The second layer includes a download server (DLS) 413. The client layer includes clients 415.

Customers 401 provide information to the procurement server EPS 403. The procurement server EPS 403 exchanges information with the database server DBS 405. The database server DBS 405 maintains databases according to the present invention. The data include advertisements (hereinafter ADs, or AD for an advertisement), messages attached to the AD for more detailed information, and control and monitoring information such as keywords selected or typed by the user, and the presentation history of the ADs, etc. Preferably, multiple database servers DBS's are provided to accommodate a large amount of data. The operator 407 controls the system of the present invention via the monitor and control server MCS 409. The monitor and control server MCS 409 exchanges information with the database server DBS 405, advertisement distribution server ADS 411, and the download server DLS 413. The advertisement distribution server ADS 411 delivers and handles information other than ADs between the client 415 and the monitor and control server MCS 409 and the database server DBS 405. Preferably, a primary advertisement distribution server ADS and multiple backup ADS's are provided for load balancing and redundancy. The download server DLS 413 receives ADs from the database server DBS 405 and exchanges other information with the monitor and control server MCS 409. ADs usually contain multimedia data which have a large size. The download server DLS 413 is preferably located in local server groups of an ISP (Internet Service Provider). Also preferably, a primary DLS and multiple backup DLS's are provided for load balancing and redundancy. The clients 415 download ADs from the DLS 413 and exchange other information with the advertisement distribution server ADS 411.

Customers who benefit from the present invention includes free ISPs, regular ISPs, paid-by-seeing services, membership organizations, and intra-company messaging services, etc.

### Information Downloading

The present invention downloads information, typically ADs, in advance in the local storage of the client to show the information instantly upon a mouse click. The AD files are downloaded while the user activity is low in order not to interfere with the user's activity. To achieve this, both the server and client follow carefully designed protocols. The client software constantly monitors the user's network access speed and only when the user does not use the bandwidth actively, does it download the advertising contents from the download server DLS 413. The client software 415 constantly reports the AD inventory and presentation status to the advertisement distribution server ADS 411. The ADS 411 determines what AD files to download next.

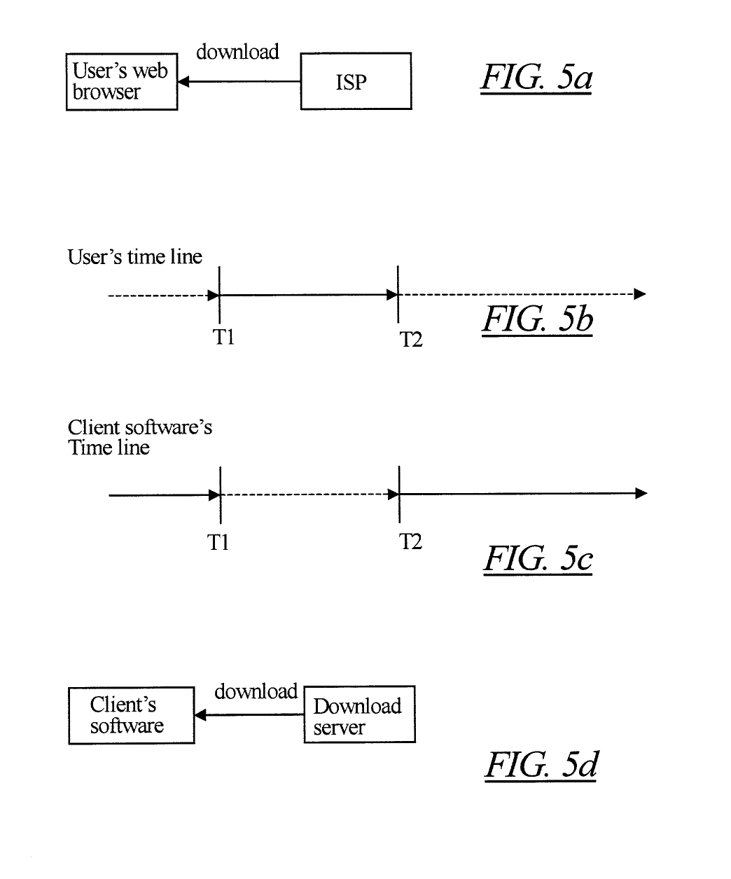

FIGS. 5a, 5b, 5c and 5d illustrate the process of background information transfer of the present invention. In the timelines of FIGS. 5a-5c, a solid line indicates that a download is being performed and a dotted line indicates that a download is not being performed. The interval between times T1 and T2 represents the period that the modem of the user's computer is being actively used for a user's intended action such as loading a web page or for a file download from an ISP. Downloading of ADs from the download server to the client continues in the background except the period between times T1 and T2. The user is unaware of this background downloading activity. Although FIGS. 5a-5d illustrate the alternating state of solid lines and dotted lines, for a clear understanding of background download without interfering with a user's activity, background downloading continues when the activity of the user's timeline is low below a pre-determined threshold value, so as to exploit the remaining bandwidth available in the Internet connection

### Information Presentation

The present invention divides display time rather than display screen space to present information. During the reserved time slot for presenting information, the client software presents the information in a full-browser mode to maximize the user's attention to the displayed content. For example, an AD is presented in the entire display pane of a web browser. For the time slot, the transition time from one page to another is utilized as illustrated in FIG. 2. A user clicks a link in the web browser or navigates to a web page by typing the address (URL) in the address bar. The client software detects the URL and text information, then runs a matching algorithm to search for AD inventory as described in the next section. The client software also detects whether the downloading time of the target web page exceeds a pre-determined threshold value. If it does, then a matched AD is presented. During the presentation time, user's web browser downloads the target web page as usual. Once the AD is presented for a contracted time, the AD disappears from the web browser, showing the targeted web page whether it is fully downloaded or not. Alternatively, the duration of the presentation can be extended until the target page is fully downloaded. If the target page is fully downloaded before the contracted time elapses, the presentation stops. The time interval for showing the full-browser information is dynamically configurable within the client or from a remote server. For example, the presentation can be made for every mouse click, or once in a user-defined number of minutes. The duration of the presentation can be flexibly configured either as a predetermined time or until the downloading is finished. The presented information may be informational, or paid advertising. The physical format of the information may be various, including multimedia animations, videos, banners, static images, HTML pages, letters, etc. In other words, any format that is supported by the operating system can be presented.

The present invention uses a virtual browser to display the information. The client program detects the exact size and position of the display pane of the web browser and overlays the presentation of an AD on the pane so that the entire display is replaced by the presentation. This virtual browser does not hinder the operation of the web browser since only the screen display is overlaid. The user can still view and click the menus and bars of the web browser. As a variation of a full browser display, a partial browser display is allowed. It may use a part of the display pane of the browser or a screen space outside the browser for those users who might want to view the browser action even if it is blank or partly loaded.

### Client Control of Matching and Frequency of Information Presentation

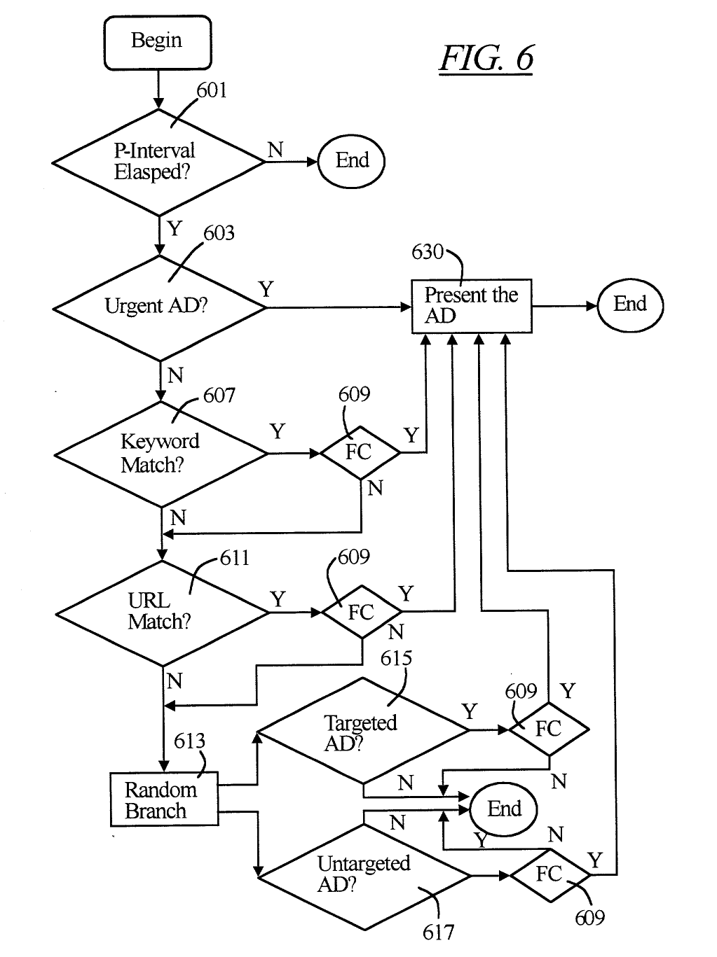

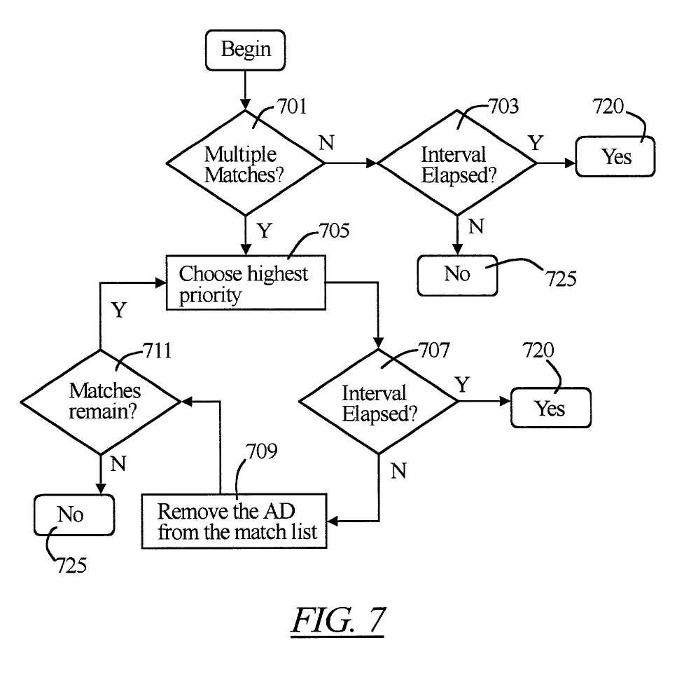

Once the AD files are delivered to a client, the client determines what AD will be shown from the AD inventory with its own intelligence. That is, the client program performs a matching of individual user's preference locally on the user's computer. The matching function is initiated when the user clicks a link or types the target URL. When such an event occurs, the target URL and text for the link is collected, and are processed with these algorithms as illustrated in FIG. 6 and FIG. 7.

The matching algorithm includes a presentation interval, an urgent message, a URL, keyword, and targeting as its matching criteria. FIG. 6 illustrates a detail example of the matching.

Presentation interval matching is to avoid annoying users since too frequent presentation of ADs may bother the user. ADs are not shown at every click. The client shows an AD after a certain period of time from the last presentation of any AD, for example 3 minutes. If this time is not reached, it does not show an AD. The interval is dynamically configurable within the client or from a remote server.

Urgent message matching is a provision for urgent information delivery, which overrides all other matching criteria. An urgent message tag is attached to an AD by the request of a customer. When the AD is downloaded to the client, it waits the first chance of presentation. After it is presented, the urgent message tag is removed.

Keyword matching is to incorporate the user preference in the selection of an AD from the AD inventory. The keyword includes the domain name portion of the URL that the user typed, or associated with a link that the user clicked, and the strings in the text associated with the link. The keyword in its narrow sense indicates the text strings.

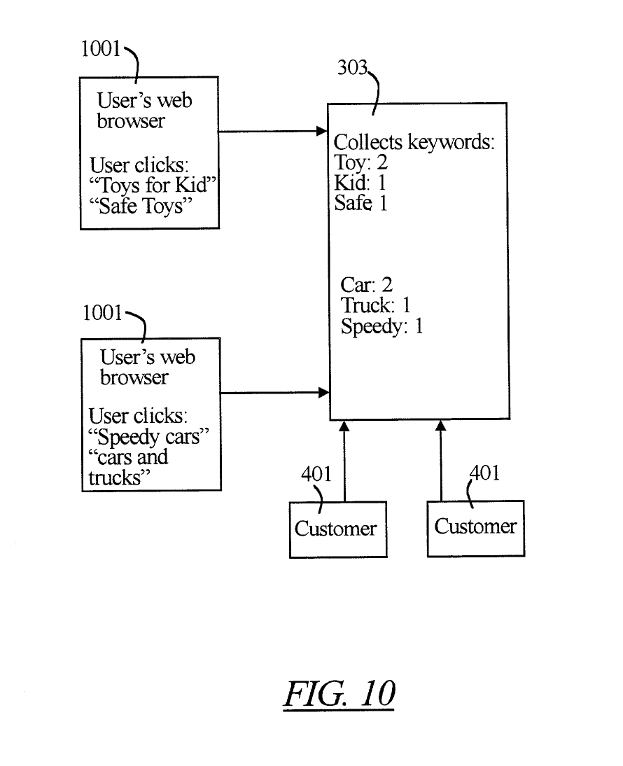

The client software reports the collected URLs and keywords, and a presentation history of ADs to the ADS 411. The presentation history includes the time when the AD was presented, times of presentation of the AD, and the duration of presentation of the AD. The reports are stored in the database server DBS 405. The customer 401 uses the reports to evaluate each user's general preference and gives his AD a target for a certain user's preference. Evaluating user preference and targeting of an AD are explained later with regards to FIG. 10. Preferably, targeted ADs are presented when there is no match for the above matching criteria. Although it does not match the context, it is still effective since it matches the user's general preference. Untargeted AD's, that is ADs having no target are also intermittently selected with targeted ADs. This ensures that all ADs will eventually be presented.

Before the matched AD is presented, it is further tested with other criteria which deal with the case when there are multiple matches and which incorporate an advertisement presentation contract with the customer. FIG. 7 illustrates this process. When there are multiple matches, a match having the highest priority is chosen. The priority is given to each AD by contract with the advertisement customer, and increases as the time that the AD is not presented increases. As an alternative, the priority increases as the times when the other presentation is performed but the AD is not presented increases. Then the chosen AD is tested for contracted presentation times and per-AD presentation intervals. The contract specifies how many times an AD will be presented. If the contracted number of times is not consumed, a check is performed as to whether the interval between the presentations for the AD has elapsed. This per-AD interval is to avoid user rejection for consecutive presentations. The interval ranges from minutes to days. If the interval has not passed, the client does not show that advertisement. The interval is dynamically configurable within the client or from a remote server.

The above is an example of one particular case, but in general it can be configured in any order and in any combination. Basically, the selection is made through a multi-level queuing model and it is guaranteed that all the advertisements are eventually presented. Even in the broadband environment, there is always download delay due to network congestion or server overloading or database access. The client software can be made to detect such spots for more user-friendly presentation.

FIG. 6 is a flow diagram of a routine which applies matching algorithms to ADs. The routine begins when the user clicks a link or types an URL.

Presentation Interval match: in step 601, if a predetermined presentation interval has elapsed since the last presentation of advertisement, then the routine continues at step 603, else the routine ends.

Urgent match: in step 603, if there is an advertisement which has an urgent tag, the routine continues at step 630, else the routine continues at step 607.

Keyword match: in step 607, any keyword in the text associated with the link clicked is matched with ADs. If there is a match(s), then the routine continues at step 609 (FC), else the routine continues at step 611.

Priority and frequency control: step 609 (FC) is a subroutine that applies priority rules when there are plural matches and performs frequency control of each AD. FC is described below with FIG. 7. If the output of FC is yes, the routine continues at step 630. If the output of FC is no, it has the same effect that the result of the step calling FC is no.

URL match: in step 611, the domain name portion of the URL that the user typed, or that is associated of the link that the user clicked, is matched with ADs. If there is a match(s), then the routine continues at step 609, else the routine continues at step 613.

Random Branch: in step 613, step 615 or step 617 is selected randomly.

Targeted AD: in step 615, if there is a targeted AD(s), then the routine continues at step 609 (FC), else the routine ends.

Untargeted AD: in step 615, if there is an untargeted AD(s), then the routine continues at step 609 (FC), else the routine ends.

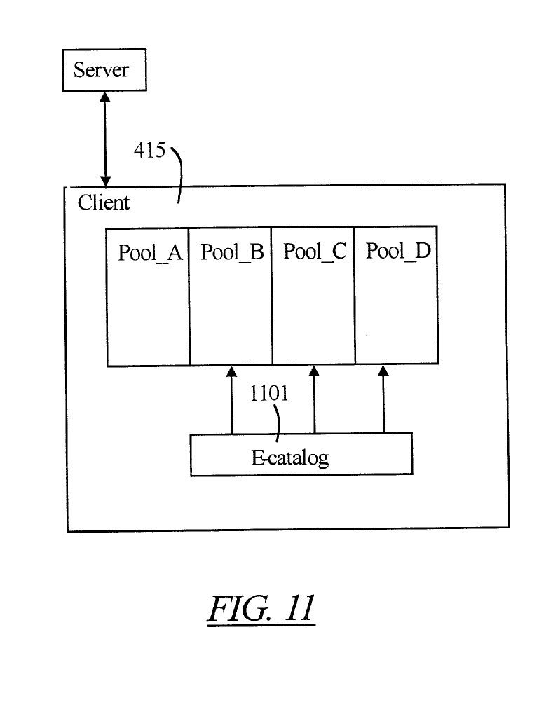

AD presentation: in step 630, the AD selected by the matching steps is presented; the presentation counter of the advertisement is decreased by 1; and the routine ends. If the counter becomes 0, the AD is removed from the AD storage pool. The expiration process is explained later with regard to FIG. 11.

FIG. 7 is a flow diagram of a routine, which applies priority rules when there are a plurality of matches and performs a frequency control of each AD. In step 701, if there are multiple matches, then the routine continues at step 705, else, that is, when there is a single match, the routine continues at step 703. In step 703, if the per-AD interval has elapsed since the last presentation of the AD, then the routine continues at step 720, else the routine continues at step 725. In step 705, the AD having the highest priority is chosen and the routine continues at step 707. In step 707, if the per-AD interval has elapsed since the last presentation of the AD, then the routine continues at step 720, else the routine continues at step 709. In step 709, the AD is removed from the match list and the routine continues at step 711. In step 711, if there is a match(s) remaining in the match list, then, the routine continues at step 705, else the routine continues at step 725. In step 720, the routine outputs yes and the selected AD. In step 725, the routine outputs no.

### Integrated Advertising Via Transition from Full-browser AD to Banner AD

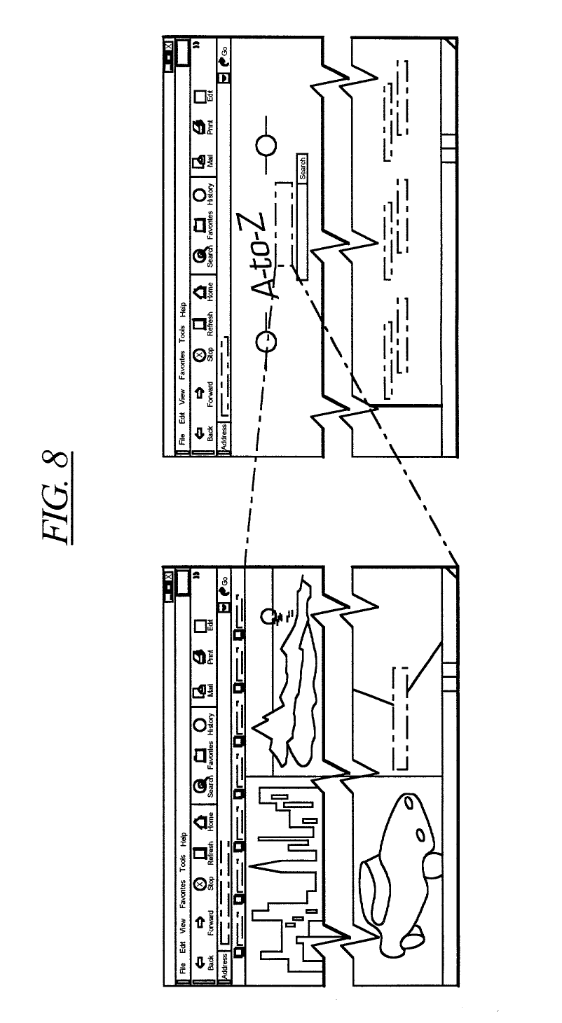

In another aspect of the present invention, the full screen AD becomes a banner in the target web page. In case that an AD is a banner-integrated type, a banner is delivered with the AD when the AD is downloaded in the background. When an AD is presented, the client software checks if the type of the AD is integrated; checks that the type of the target web page is integrated; and then provides the banner to the target web page. The target web page detects if a banner is provided by the client software and then embeds the banner. By integrating banner and full-screen multimedia advertisement, an advertiser can provide a continuous impression to the end-users. FIG. 8 illustrates the integration of a full-screen AD and a banner AD.

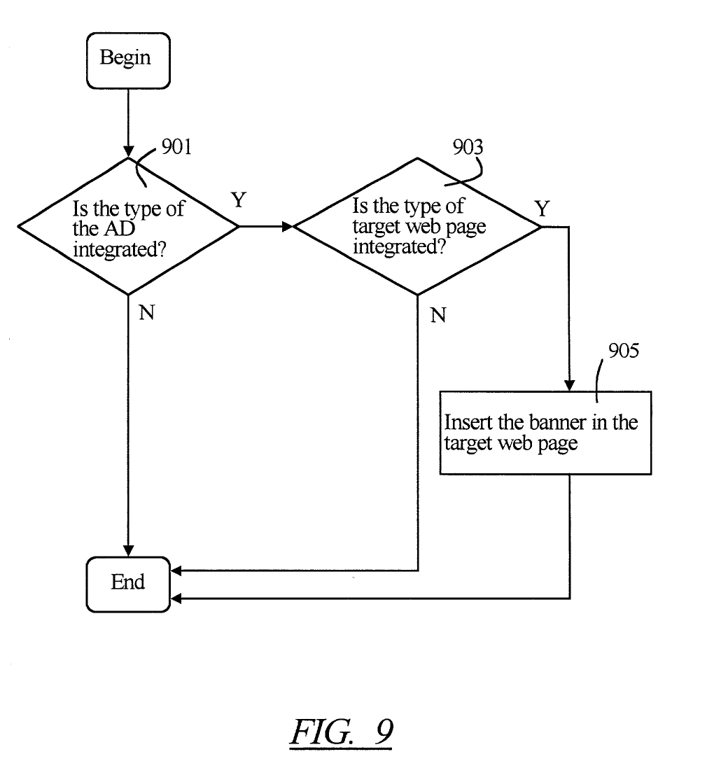

FIG. 9 is a flow diagram of a routine that performs the process of integrated AD presentation. The routine begins when an AD is presented. In step 901, if the type of the AD is integrated, then the routine continues at step 903, else the routine ends. In step 903, if the type of the target web page is integrated, then the routine continues at step 905, else the routine ends. In step 905, the banner of the AD is retrieved from the AD inventory and the target web page embeds the banner. Then the routine ends.

### Profiling and Targeting

The client software reports all the Internet access activities and the server analyzes them for targeted AD placement. An untargeted AD can be provided without a profiling analysis. The client software collects URLs that the user types or clicks, and the text strings that the user sees when she clicks links as keywords representing the user's Internet access activities. Thus, keyword includes both URLs and text strings when they are considered with regard to profiling and targeting. Among the keywords collected, a predefined set of keywords is used for analysis. The set of keywords is selected so that the keywords effectively reflect user's preferences and avoid certain words to protect a user's privacy. The set of keywords is open to the user before the client software is installed.

The keywords are sorted by frequency of use and stored in the database. Keywords which are used most frequently form the user's profile and these keywords are used for selecting the target audiences using a query composed of “and” and/or “or” for the keywords.

Unlike a URL (Uniform Resource Locator), the text strings represent precise user interests, and the advertisers can place ADs with their own analysis and responsibility rather than blindly trusting the third party profiling. For example, for showing an AD for best target for buying a mother's day gift, a query may look like ((mother and shopping and gift) or (card +mother+flower)) or in any combination of “and” and “or”. All the targeting information is collected without a user survey and done entirely anonymously. All the client software has a unique identifier that can be used for behavior tracking, but there is no connection to the identifier number and user's real identity. So a user's privacy is guaranteed.

FIG. 10 illustrates the log report and profiling process. Although only two clients 415 and two customers 401 are shown for ease of illustration, there maybe hundreds of customers and a far greater number of clients. In one user's web browser 1001, the user clicks links that have associated texts, “toys for kid” and “safe toys.” In another user's web browser 1001, the user clicks links that have associated texts, “speedy cars” and “cars and trucks.” The clients 415 report the log of keywords to the server 303.

The server 303 collects the keywords and their number of occurrences from the log report for each client. The keywords and their frequency are stored in the database together with each client's identifier as a user preference. A customer 401 may query “How many subscribers are interested in toys and who are they?” Another customer 401 may raise a similar query for cars.

Through individual user profiling, the present invention provides an effective way of individually targeted advertising. ADs are presented adaptively according to a particular user's detailed preference. By analyzing the user activity such as visited URLs, text strings associated with links clicked, user's frequently visited sites, and frequency of visits, the server can deliver a highly targeted advertisement customized for individual users. End users see more relevant advertisements that interest them more, thus AD awareness is increased. Consequently, the advertisers have higher AD effectiveness, and more revenue.

### Information Archival and Retrieval

The short presentation of an AD is good for creating a branding image, but the time may not be enough for the users to interact with the sponsor's web page which correspond to the AD. An e-catalog is provided to archive ADs for later retrieval. The ADs are cataloged under hierarchical categories by their contents for a quick search. Besides ADs, entries in the catalog include information attached to the ADs, and a web site whose URL is embedded in the AD.

FIG. 11 illustrates the AD archival process in the e-catalog system. The e-catalog 1101 is part of the client 415. The AD inventory of the client 415 comprises four pools of ADs, pool_A, pool_B, pool_C, and pool_D. Each AD delivered to the client includes as its attachment supplemental data such as a phone number, location, sale information, major products, etc, related to the AD. When an AD is delivered to a client 415, the AD is stored at pool_A. Pool_A stores ADs that have not been presented yet. If an AD is presented during the user's browsing, the AD is moved to pool_B. Pool_B stores ADs that are presented at least once but have not yet been presented up to their contracted presentation times. If an AD finishes presenting by the contracted times, then the AD moves to pool_C. ADs are stored in pool_C until they are automatically removed after a pre-defined expiration period, for example, one month. The user can select an AD in the e-catalog so that it is not deleted automatically. In this case, the AD moves to pool_D. All of the ADs in pool_B, pool_C and pool_D are mapped to hierarchical AD entries in the e-catalog. That is, once an AD is presented, it is added to the e-catalog as one of its entries. Each entry of the e-catalog is deleted after the expiration period without bothering the user. However, if the information is useful for the user, the user may choose to save an AD permanently in the e-catalog. The customer can update the attached data of an AD so that the user may have the latest information about the purchase information.

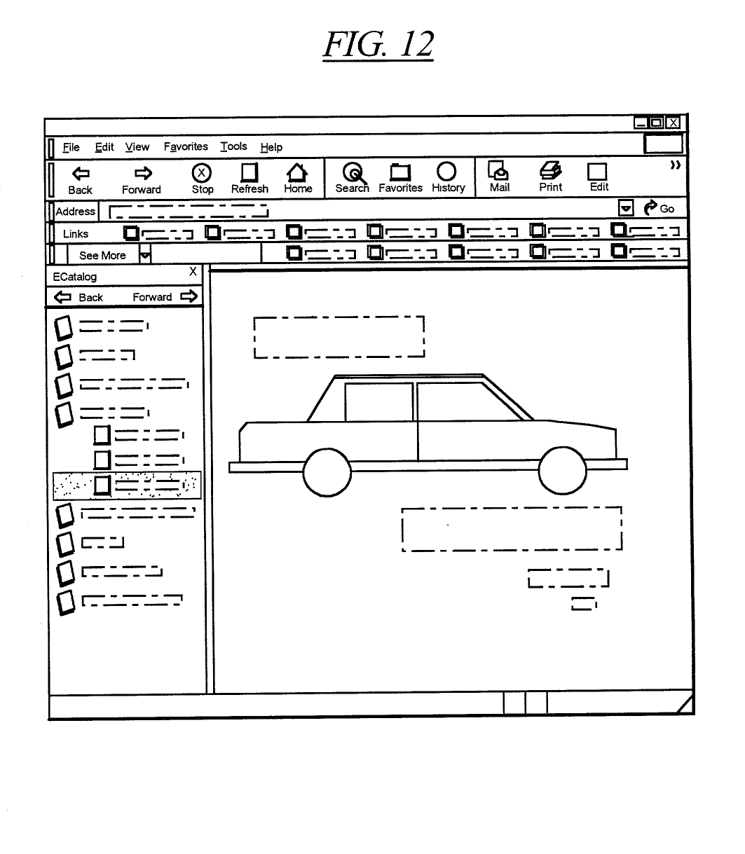

The e-catalog is automatically invoked when the user shows an interest in an AD being presented. When the user clicks an AD during the time that it is presented, or when the user clicks the banner in a web page, which is related to an AD presented just before, the e-catalog is invoked as illustrated in FIG. 12. The user can also positively invoke the e-catalog after an AD is presented. When the user clicks an e-catalog button in the web browser or clicks a desktop icon, the e-catalog browser is activated inside the web browser as illustrated in FIG. 12.

The e-catalog also uses a virtual browser to display information. The e-catalog detects the exact size and position of the display pane of the web browser and overlays the presentation of an AD or attached information on the pane so that the entire display is replaced by the AD or information. This virtual browser does not hinder the operation of the web browser since only the screen display is overlaid. The user can view and click the menus and bars of the web browser.

FIG. 12 illustrates the e-catalog when it is invoked by the ways explained above. A hierarchical category list is shown at the left side. A display pane for an AD or its attached message is positioned at the right side. The display pane displays the AD presented just before the e-catalog is invoked or the attached message of the AD. On top of the list, there are two browsing buttons, Back and Forward. By the buttons, the user can browse ADs in the order they were presented.

When the user clicks a button, selects a menu, or types an URL on the address bar of the web browser, the display pane switches to web information display. When the user clicks the browsing buttons, or categories of the e-catalog, the display pane switches back to the e-catalog information display.

When the user clicks an entry, the corresponding AD is played or the attached catalog message can be viewed. The clicking information is collected and reported to the server. The end-users can easily do Internet shopping online by using the information in the e-catalog. In an off-line state, the user can refer to the e-catalog to retrieve shopping information. The e-catalog archives the Internet shopping information systematically without the need of saving each AD by a user's explicit saving action.

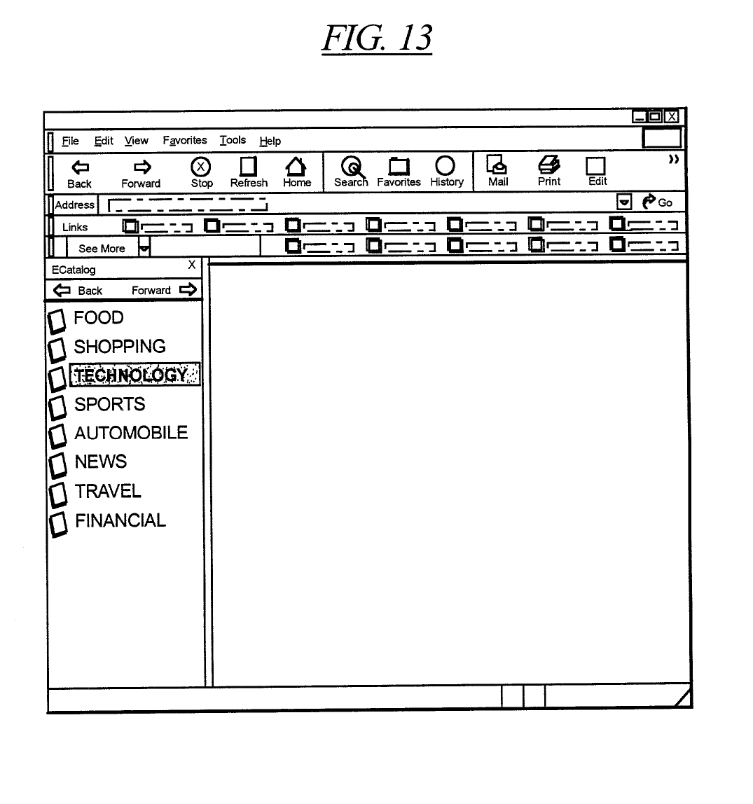

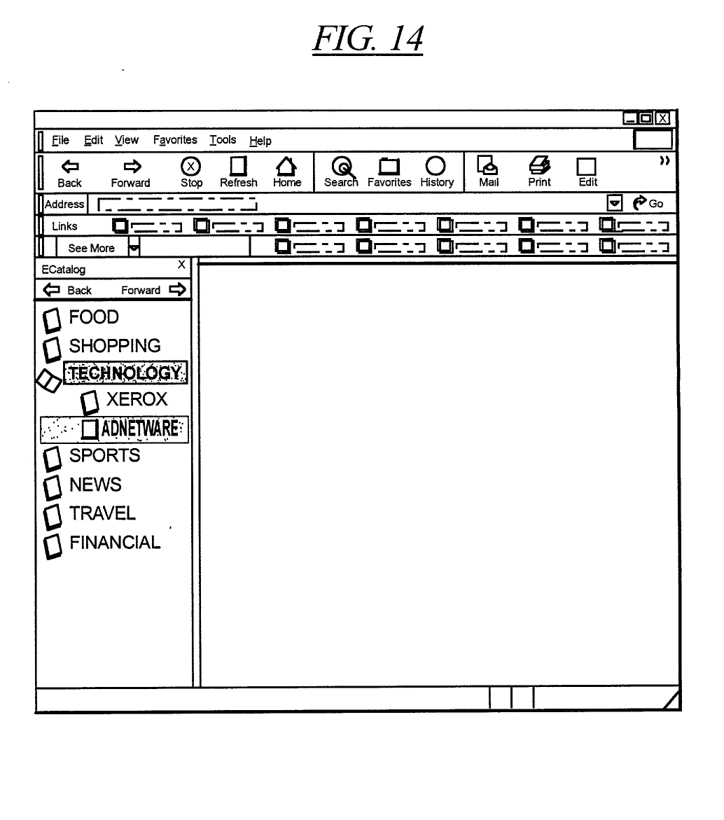

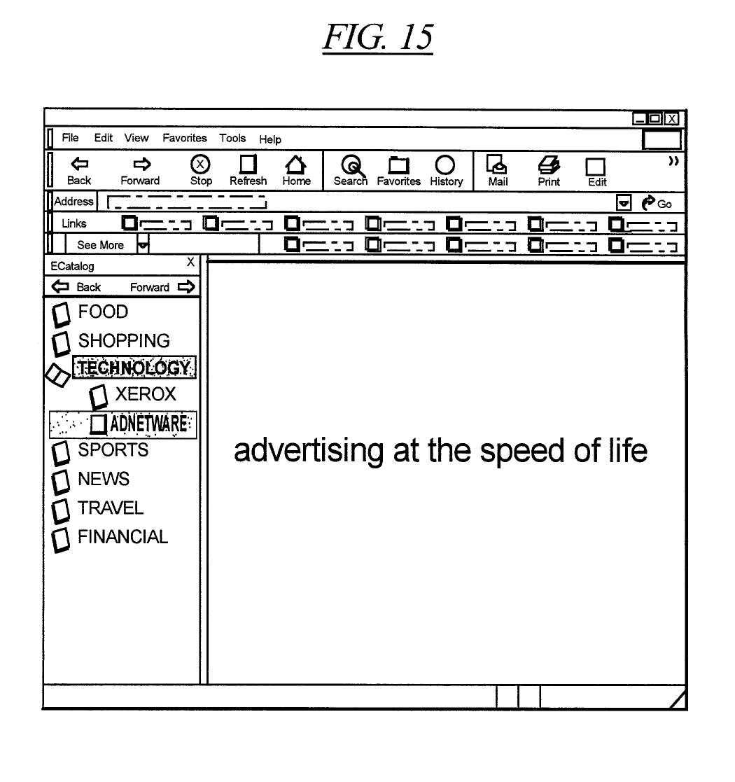

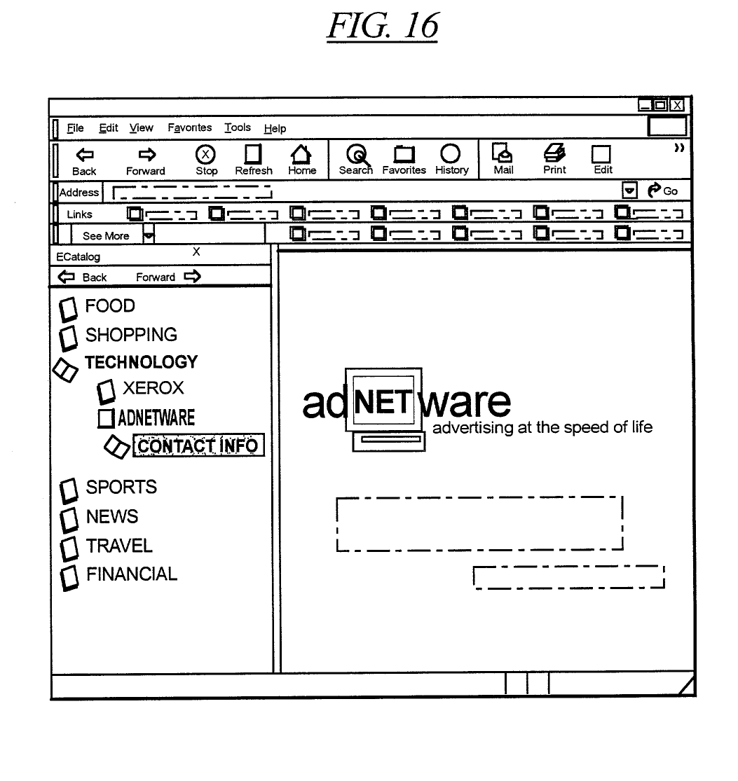

FIG. 13-16 illustrate an e-catalog display example. When the user clicks the “See More” button on the e-catalog toolbar, two panes of the e-catalog are displayed on the web browser's window. The e-catalog toolbar is integrated with the web browser when the client program is installed on the user's computer. FIG. 13 illustrates that the user selected a high level entry, “Technology” by bringing the mouse pointer over the entry or clicking the entry. In the next step, as illustrated in FIG. 14, one middle level entry, “Adnetware” and one low class entry, “Xerox” are displayed. FIG. 15 illustrates that the AD of Adnetware is presented in the right pane and the low level entry that is associated with the attached message of Adnetware appears in the left pane when the user selected the entry, Adnetware. When the presentation is completed, or the user clicks the low level entry, the attached message is presented in the right pane as illustrated in FIG. 16.

The toolbar provides a handy means for retrieving information of interesting fields or presenting short messages to the user instantly. The items in the toolbar and arrangement of them can be configured by the client or the server. The items include news and info, magazines, billing info, clothing size, preferences, and mailing addresses, etc.

The e-catalog provides means for gathering and storing online information in the user's local storage. The e-catalog presents the stored information in a well-classified fashion so that the user can quickly locate the information. Since an AD is added to the e-catalog after it is presented once, the e-catalog is friendly to the user since she has already seen all of the ADs in the e-catalog.

Still a lot of purchases are made by conventional ways other than online shopping based on online information gathering. The e-catalog provide the users with vital information such as phone number of the company, location, directions, coupons, store hours, discount offers, major products, etc, to help the users purchase products by conventional ways. Even if the reference to the e-catalog information is made off-line, the client still records the browsing activity so the merchants can verify the advertising effect against the changes in sales.

Considering that most users want to collect product information before purchasing, off-line advertising and/or product information is needed by both the users and the advertisers. An advertiser of a product will have an advantage over its competitive products by giving the users more exposure to its own products. Many users choose to purchase later rather than at the moment when the AD is presented. Advertisers can have more delayed purchasing from the locally stored e-catalog and track the advertising information access statistics very precisely.

The e-catalog helps the end-users to backtrack to the previous AD and to collect product information, helps the advertisers to increase brand-awareness and sales revenue, and provides a technical solution to the traditional AD agency for applying their expertise from the traditional advertising business into the Internet advertisement with the end-to-end solution.

The client reports user's browsing activity, the presentation status of each AD, and usage of the e-catalog in pseudo-real time when it is online. The customers can monitor their AD's performance in pseudo-real time and the adjustment of control information of ADs can be done in pseudo-real time.

### Real Time AD Performance Monitoring and Controlling

Customers who provide the information to be presented by the client can check the effects of the advertisement based on the analysis of data, which includes user's browsing activity, the presentation status of the advertisements, and usage of each entry in the e-catalog. Customers can also control the priority and targeting of the already delivered advertisement materials and can decide new advertisements and their control information.

Data transfer required for these activities does not require much bandwidth since the data is small. Transfer of the data is performed in real time whenever it is needed unlike the case of advertisement downloading. Thus, the present invention makes it possible to monitor and control AD performance in real-time and adapt it according to a user's detailed preference.

The present invention is thus based on several concepts:

Interstitial advertising: After the user leaves a page and waits for another page to load, there is usually a few to several seconds of gap. Showing an advertising message in this time is less annoying because while a user is looking at old page or blank page anyway, and user is naturally expecting a transition. Showing a message instantly upon a click gives the users the impression that web access speed is faster. An interstitial gap tune can be placed so that multimedia advertising can be presented. The problem is that most of this type of advertising is presented in a pop-up window that blocks the users' view even after download.

The present invention solves this problem by showing the AD within the browser for a short duration. Once the contracted time is expired or the target page is loaded, the AD presentation is stopped. The present invention binds into the existing Internet Browser and controls this presentation.

Background downloading using unused bandwidth: Another problem of the interstitial ads is that it usually follows from users target pages, thus interfering with user's bandwidth. The multimedia-advertising file tends to be bigger than banners, but the present invention downloads the ads only when the user is not using the modem actively.

Another cost saving feature follows from the server allocation with ISP Point-of-Presence facilities. The advertising files are first delivered and stored at the POP, and the user downloads the file from the POP, not a server on the Internet, thus saving valuable bandwidth for ISP and user download speed is not affected by the Internet congestion. The present invention can be configured to be con-located with the ISP POP.

New Protocol: To achieve the background file transfer and log reporting, an advanced protocol is required between the central server and the server in the POP, and between the client software and the server software in the POP. The present invention has a suite of protocols and all of its software is built around that protocol.

TV-Like multimedia Advertisement: Instead of banner ads, the present invention presents TV-like full-browser advertisements, which makes the users experience more enjoyable and increases the advertising effectiveness. In fact the same TV commercial can be converted to this format and presented.

Guaranteed Notice: The advertisement is present inside the users' browser, so users cannot close the window, that is, exposure is guaranteed to the message. The presentation time is short; so, users are unlikely to turn away form the computer screen for such a short duration.

Active AD delivery: Like TV, the present invention delivers the AD messages right into the users' eyes instead of waiting until a user visits.

Targeting: The present invention reports the users' activity to the servers, which is carefully analyzed to profile the users' interests, all anonymously. Advertisers can place an ad for an individual's specific interests, or target the ad when the user visits specific sites.

The present invention provides true geographic targeting based on the ISP POP location. Local advertising is more than 40% currently and it is on the rise.

For ISP customers, the present invention offers integrated dial-up software, which tightly combines the present inventions, software with the client software and ISP dial-up software. Using this, the subscribers can dial up the ISP and login even without typing the user ID and password. This way, a user's privacy is guaranteed. Conventional targeting relied on a user's input during registration, but the present invention does not need require this registration process.

E-catalog: Losing track of old advertising information or lack of off-line information gathering could be annoying for the users and mean lost revenue for the advertisers. Every advertisement and its attached product information are stored temporarily in the E-catalog of the present invention, which can be instantly accessed by pressing a browser button. Users can conveniently browse the information by category. The E-catalog can store more than advertising material but it contains valuable shopping information such as coupons, telephone number, address, driving directions, open hours, and theater schedules, etc.

For portable advertisement information storage: the content of e-catalog is conveniently synchronized with portable devices such as a PalmPilot or other personal organizer. The present invention is built on the Internet and is distributed among multiple locations. The servers for the present invention are highly scalable, easily expandable to at least 10 million subscribers. Users can simply carry the portable device and enjoy the coupons and shopping information anytime and anywhere.

Software Suite: The present invention comprises the following units and features:

Ad Agent (AG)—Residing in the end user's browser, Ad Agent provides the following capabilities: Presents internet advertisement according to the advertising contract at the visiting web site; communicates with the AD server and downloads advertising files; and provides e-cataloging.

Portable Agent (PAG)—It is installed at user's portable device; synchronizes the E-catalog with the PAG; and keeps advertiser's information for off-line use.

Ad Distribution Server (ADS)—Residing in ISP's POP facility, it has these capabilities: communicates with the IAS; sends advertising files to AG; monitors AG status and collect logs from ADS; and sends the collected log information to IAS.

Intelligent Ad Server (IAS)—Residing at the facility, it provides the following capabilities: Keeps all the data in database; interacts with EPI to support all its activity, communicates with ADS to distribute the advertising material and collect the log; profiles the subscriber activity based on log; and analyzes advertising campaign effectiveness in real-tune.

Electronic Procurement Interlace (EPI)—Being a web server, it is accessible from anywhere: provides Interaction to ISP clients, advertisers and AD agencies; Business-to-Business E-commerce for AD contract management; lets clients register, submit or renew their contract information; lets advertisers/ad agencies to make individual advertisement contracts, and submits the advertising file.

Real-time advertising result browsing for analysis & decision support Cl produces a sophisticated report for the market research.

Message Delivery Network and Process: In the present invention, the network architecture is composed of 3-tier components, two server layers and one client layer. The top layer servers have all the core database, advertisement posting/monitoring, target profiling and web interface. tThe second layer servers can be placed anywhere in the TCP/EP networks to receive the contents and deliver to the end-users. Multimedia files are larger and take more bandwidth, so serving all the clients from one place may overload the network. By distributing the servers for final delivery at the edge of the network, the advertising files are delivered once to the delivery servers, thus avoids the network congestion and reduce the network cost. Two-layer server architecture helps to reduce the network traffic, thus, accelerating the speed and reducing the network cost. Under a light load, those two servers may be merged. The figures further illustrate the file distribution process. On the top layer server, the advertiser browses the subscriber information, and uploads the advertisement. The client interface, possibly by web interface, shows the number of total subscribers, number of targeted group, the advertising price, etc. Once a message is uploaded, it is delivered to tier 2 servers and they notify the clients' software to download the messages. The client then retrieves the messages autonomously.

Message downloading: To show the message instantly upon a mouse click, the computer file containing the message must be present in advance in local storage. The advertising files are downloaded while the user activity is low. To achieve this, both server and client follow carefully designed protocols. The client software monitors users' networks access speed. Only when the user does not use the bandwidth actively, it downloads the advertising contents. The client software constantly reports the inventory and presentation status to the server. The server determines what files to download next. The Figures describe the non-interfering download process.

Client Presentation: In this present invention, full-browser-based on-click instant presentation is used. Traditional advertising methods over the Internet use some kind of banners or pop-up windows of which content is delivered along with the users' content, thus interfering with each other in bandwidth and in screen space. This invention divides presentation in time rather than screen space. During the reserved time slot, the client software presents the message in full-browser mode to maximize the user's attention. For this time slot, the transition time from one page to another is utilized where users must endure blank screen or they are nervously waiting for the new web page downloading. The Figures illustrate the process. A user clicks a link in the web browser or navigates to a web page by typing the address in the address bar. The client software detects the URL and text information, then run the matching algorithm to search for advertising inventory as described in the next section. During the presentation time, user's web browser downloads the target web page as usual. Once the advertising is presented for the contracted time, the advertising disappears from the web browser, showing the targeted web page whether it is fully downloaded or not. The duration of the presentation can be extended until the target page is fully downloaded. Showing a full browser advertisement during the transition time has several advantages. Users feel as if the web access speed becomes faster, adds more fun to watch the animation instead of a blank page. During the transition time, users are naturally expecting a transition and the attention level is high, and no other information is cluttered during this time, so the effectiveness of advertising is very high and less annoying. The presented message could be informational, or paid advertising. The physical format of the message could be various, including multimedia animations, video, banners, static images, HTML pages, letters, etc. In other words, any format that is supported by the web browser can be presented using the present method.

Frequency control and matching control at Client: Once the advertising files are delivered to a client, the clients determine what message will be shown from the advertising inventory with its own intelligence. This algorithm tries to match individual user's preference locally on a user's computer. Note that the messages are only shown when the user clicks a link or types the target URL. When such an event occurs, the target URL and text for the link is collected, and is processed with these algorithms as illustrated in the Figures.

Interval match: Messages are not shown in every click. To avoid annoying users, the client show the message after a certain period of time from the last presentation, for example 3 minutes. If this time is not reached, it does not show an advertisement. If the web page is cached in a local hard drive, do not use this time slot.

Priority match: For very a urgent message, the present invention shows the highest priority message first.

URL match: When the domain name portion of the URL matches any of the advertising, the client software picks up the matched advertisement. When there are multiple matches, the highest priority advertisement is selected.

Keyword match: When any keyword in the text link matches any of the advertising, the client picks, and there are multiple choices, it follows the priority rule as above.

Multiple presentations: A message can be presented only once or multiple times depending on the contract. In case of multiple presentations, it has a contracted interval time between the presentations to avoid user rejection for consecutive presentation. This interval ranges from minutes to days. If this interval is not passed, the client does not show this advertisement.

Targeted non-context match: If none of the above match methods succeeds, a targeted advertising which was not presented for a while is picked up. Although it did not match the context, it is still effective since it matches the user's general preference.

Untargeted match: When there is untargeted advertising delivered, this is selected intermittently with a targeted non-context match.

The above is an example of one particular case, but in general, it can be configured in any order and in any combination. The selection is made through multi-level queuing model and it is guaranteed that all the advertisements are eventually presented. Even if in the broadband environment, there is always download delay due to network congestion or server overloading or database access. The client software can be made to detect such spots for more user-friendly presentation.

The time interval for showing the full-browser information is dynamically configurable within the client or from a remote server. For example, the presentation can be made for every mouse click, or once in X minutes. The duration of presentation can be flexibly configured either a predetermined time or until the downloading is finished.

Integrated advertising via transition from full-browser ad to banner ad: Optionally, the full screen advertisement becomes a banner in the target web page. The target web page is configured to detect the full screen presentation and to embed the banner that is delivered together with the full screen advertisement before the page is delivered. By integrating the banner and full-screen multimedia advertisement, an advertiser can provide a continuous impression to the end-users. The Figures illustrate the integrated advertisement of full-screen advertisement and banner advertisement including the integrated ad presentation.

Targeting and profiling: The client software is capable of reporting all the Internet access activities and the server is capable of analyzing it for targeted advertisement placement. Untargeted advertisement can be provided without profiling analysis. In the present profiling, not only are the URLs collected but also the actual text string that the user sees is collected. Those words are sorted by the frequency and stored in our database. The Figures illustrate the log report and profiling process. The most used words form the user's profile and this words are used for selecting the target audiences using a query composed of “and” and/or “or” for the words. This is superior to other profiling methods where the profiler profiles the user by heuristics based on visited web sites. Unlike a URL, the text link provides precise user interests, and the advertisers can have placed the advertisements with their own analysis and responsibility rather than trusting the 3rd party profiling. For example, for showing the ad for best target for buying a mother's day gift, the query may look like ((mother and shopping and gift) or (card+mother+flower)) or in any combination of “and” and “or”. In the present invention, all the targeting information is collected without user survey and done all anonymously. All the client software has a unique identifier that can be used for behavior tracking, but there is no connection to the identifier number and user's real identity, so a user's privacy is guaranteed.

Through individual user profiling, this invention provides an effective way of individually targeted advertising. Although current Internet advertising is presented in an embedded banner on web pages, it is not presented adaptively according to a particular user's activity. By analyzing the user activity such as a visited URL, types of the URL, user's frequently visited sites and their types, frequency of visits for each type, the server can deliver highly targeted advertisement customized for individual users. End users will see advertisements that are relevant, increased attention by the viewer is then paid to the ad. Consequently, the advertisers have higher AD effectiveness, and more revenue.

Information archival and retrieval: The short presentation is good for creating a branding image, but the time may not be enough for the users to interact with the sponsor's web page. This problem is resolved by archiving the messages in the E-catalog for later retrieval. The messages are cataloged under some category for quick search. Optionally, advertisers can send an attached message for more detailed information. As illustrated in FIG. 8, an advertisement is stored temporarily along with the attached more detailed information. When the user clicks the E-catalog button in the web browser or clicks a desktop icon, E-catalog browser is activated inside the web browser or in an external program. E-catalog entries each have an expiration date for automatic deletion, but users can control the entries to store permanently or delete it. It has the function to update the downloaded information automatically. When the user clicks an entry the advertising is played or the attached catalog message can be viewed. By clicking, information is collected and reported to the server.

If the information is useful for the user, the user can permanently save it; otherwise, the message is deleted without bothering the user.

The end-users can easily do Internet shopping in either on-line or off-line mode. Still a log of purchase is made off-line based on the on-line information gathering, the E-catalog provides the users vital information such as a telephone number, location, sale information, major products, etc, to help the users purchase products off-line. Even if the purchase is made off-line, the browser still records the browse activity so the merchants can verify the advertising effect against the increased sales.

Considering that most users want to collect product information before purchasing, off-line ads and/or product information are needed by both the users and the advertisers. An advertiser of a product will have an advantage over its competitive products by giving the users more exposure to its own products. Many users choose to purchase later rather than at the moment when the AD is presented. Advertisers can have more delayed purchasing from the locally stored catalogs and track the sale statistics very precisely.

In summary, the E-catalog helps the end-users to backtrack the previous AD and to collect product information, helps the advertisers to increase brand-awareness and sales revenue, and provides a technical solution to the traditional ad agency for applying their expertise from the traditional advertising business into the Internet advertisement with the end-to-end solution.

Portable archive: The E-catalog can be made even lighter so that the critical information can be carried in a portable device. When this portable e-catalog is delivered, the e-catalog browser software synchronizes the catalogs with the PDA. The figures illustrate the synchronization between the e-catalog and the portable e-catalog.

Automatic downloading of frequently visited web pages: Most users visit limited number of favorite web sites rather than randomly visiting any site. The client software constantly monitors the user's web access activity and can analyze those frequently visited web pages more recently. When the user's download activity is low, the client software can pre-download such sites.

A method of delivering information including but not limited to multimedia advertising content using on-click full-browser instant presentation, the presentation content includes cartoons, study material, news broadcasts, etc. This advertising tool may be used for free ISPs, regular ISPs, paid-by-seeing services, membership organizations, intra-company messaging services, etc.

Archiving the presented AD information to the off-line E-catalog. The presented information is stored in the E-catalog with automatic categorization, automatic deletion and updates. Delivery of network protocols and placing of advertisements online is provided as is keyword based log information collection, targeting, profiling and presentation. Keywords can be combined in an “and, or” query. A presentation algorithm in which the delivered information is picked up and presented, and billed afterwards according to the point of presentation is provided. An integrated AD, any web site can present the full-screen multimedia advertisement and transforms it to the banner ad using this invention. Portable AD and fast AD content delivery are additional objects of this invention.

Although other modifications and changes may be suggested by those skilled in the art, it is the intention of the inventors to embody within the patent warranted hereon all changes and modifications as reasonably and properly come within the scope of their contribution to the art.

We claim:

1. A system of delivering information over a network including a server and a client, comprising:
a channel connecting the client to the server over which information is transmitted from the server to the client after activity on said channel has been determined to be below a predetermined threshold;
a storage at the client which stores the information transmitted from the server; and
a program to present the information stored at the client to a user of the client.

2. The system of claim 1, wherein said information is non-requested information, and further comprising:
a timer component of said program which monitors a time gap between a request by a user for a requested item of information and arrival of said requested item of information at the client, said timer component initiating presentation of said non-requested information at said client if the time gap is bigger than a threshold value, said timer component stopping presentation of said non-requested when one of said item of requested information arrives at said client and a predetermined time elapses.

3. The system of claim 2, wherein said storage stores a plurality of items of non-requested information, and further comprising:
a selection component of said program which selects for presentation an item of said non-requested information stored in said storage by multiple matching.

4. The system of claim 3, wherein said selection component presents said item of said non-requested information for presentation only if a predetermined interval has elapsed after a previous presentation.

5. The system of claim 4, wherein said predetermined interval is controlled by one of the server and the client.

6. The system of claim 3, wherein said multiple matching matches the non-requested information with a keyword that the client detects from a user's activity.

7. The system of claim 6, wherein said keyword includes a URL that the user clicks or types and words in a text associated with a link that the user clicks.

8. The system of claim 6, wherein said selection component selects part of the non-requested information as targeted for a user's preference that is determined by the keywords.

9. The system of claim 8, wherein targeted information and untargeted information are presented randomly.

10. The system of claim 3, wherein an urgent item of information is presented without matching.

11. The system of claim 6 or 9 wherein a material that has the highest priority is selected among plural matches.

12. The system of claim 11, wherein priority for an item of information increases as a time during which the item of information is not presented increases.

13. The system of claim 11, wherein priority for an item of information increases as times when a presentation is performed but the item of information is not presented increases.

14. The system of claim 6, wherein an item of information that has been matched is presented only if a predefined interval for the material has elapsed after a last presentation of the material.

15. The system of claim 14, wherein said predefined interval is controlled by one of the server and the client.

16. The system of claim 3, wherein an item of information is presented within predetermined presentation times.

17. The system of claim 1, wherein the information delivered includes at least one of advertisements, multi media data, cartoons, study materials, and news broadcasts.

18. The system of claim 2, wherein said program presents a banner related to the presented non-requested information integrated into the requested item of information.

19. The system of claim 1, further comprising:
a catalog in which the information is arranged in a hierarchical table by contents and a user can browse the table and select and display an entry of the table.

20. The system of claim 19, wherein said catalog is started when one of:
a user clicks information being presented,
a user clicks a banner that is integrated with a information being presented, and
a user clicks an icon linked with the catalog.

21. The system of claim 19, wherein the entry includes information presented by the system, further information attached to the information, and a web site whose URL is embedded in the information.

22. The system of claim 19, wherein said catalog is accessible both online and offline.

23. The system of claim 19, wherein said catalog categorizes the information stored in the client by their contents, deletes materials that are expired, and updates information by the server.

24. The system of claim 19, wherein said catalog includes a toolbar that is configurable by at least one of the client and the server.

25. The system of claim 2, wherein the client reports to the server contents of the information stored in said storage and usage of the information by said program and keywords extracted from a user's activity.

26. The system of claim 19, wherein the client reports to the server contents of the information stored in said storage and usage of the information by said program and keywords extracted from a user's activity, the keywords include a URL that the user clicks or types and words in text associated with a link that the user clicks, and said usage of information includes the presentation time and times of each material, and a time and number of user clicks for each entry of the catalog.

27. The system of claim 25, wherein the client report is performed in real-time.

28. The system of claim 2, wherein the server is a web server, and the client is a computer program in a user's computer.

29. The system of claim 28, wherein said program displays the information separately from a web-browser's window.

30. The system of claim 28, wherein said program displays the information in a web-browser's window.

31. The system of claim 30, wherein the information is displayed in full-window.

32. The system of claim 30, wherein the information is displayed in partial-window.

33. The system of claim 30, wherein the information is displayed independently of a browser's operation.

34. The system of claim 28, wherein said program includes a dial-up networking function.

35. The system of claim 28, wherein said program is activated automatically when a web-browser is activated.

36. A method of delivering information over network including a server and a client, comprising the steps of:
transmitting information to the client from the server when a channel connecting the client and the server is at an activity level below a predetermined threshold;
storing the information in the client; and
presenting the information to a user of the client when a time gap between the user's request for material and arrival of material is longer than a predetermined threshold value.

37. The method of claim 36, further comprising the step of:
moving the information moves to a catalog after presentation of the information, said catalog providing that the information is arranged in a hierarchical table by contents where a user can browse the table and select and display an entry of the table.
